(19) United States
(12) Patent Application Publication
(10) Pub. No.: US 2019/0257411 A1
(43) Pub. Date: Aug. 22, 2019

(54) Motor Transmission Arrangement in Particular for an Adjustment Device in Vehicles for Adjusting Two Vehicle parts Which Can Be Adjusted Relative to One Another

(71) Applicant: IMS Gear SE & Co. KGaA, Donaueschingen (DE)

(72) Inventors: Simon Albert, Bonndorf im Schwarzwald (DE); Matthias Kieninger, Villingen-Schwenningen (DE)

(73) Assignee: IMS Gear SE & Co. KGaA, Donaueschingen (DE)

(21) Appl. No.: 16/277,389

(22) Filed: Feb. 15, 2019

(30) Foreign Application Priority Data
Feb. 19, 2018 (EP) 18 000162.0

(51) Int. Cl. F16H 57/08; F16H 57/00; H02K 7/116; F16H 57/021; F16H 57/023

(52) U.S. Cl. CPC F16H 57/082; F16H 57/0018; H02K 7/116; F16H 2057/0235; F16H 57/023; F16H 2057/0213; F16H 57/021

(57) ABSTRACT

A motor-transmission arrangement in particular for an adjustment device in vehicles for adjusting two vehicle parts which can be adjusted relative to one another can include a planetary transmission with at least one pinion cage, at least one planet wheel which is rotatably supported in the pinion cage and with a planet wheel cogging, and with at least one hollow gear with an inside cogging which is engaged with the planet wheel cogging, and an electromotor with a motor shaft which can rotate about a motor shaft axle and which comprises a motor shaft cogging arranged directly on the motor shaft, which cogging is engaged with the planet wheel cogging. The disclosure also relates to an adjustment device with such a motor-transmission arrangement and to the usage of such a motor-transmission arrangement in adjustment devices.

### CROSS-REFERENCE TO RELATED APPLICATIONS

This application claims priority to European Patent Application No. 18 000162.0, filed Feb. 19, 2018, which is incorporated by reference in its entirety.

### BACKGROUND

The present application relates to a motor transmission arrangement in particular for an adjustment device in vehicles for adjusting two vehicle parts which can be adjusted relative to one another. Furthermore, the application relates to an adjustment device with such a motor transmission arrangement and to the usage of such a motor transmission arrangement in adjustment devices of vehicles.

### SUMMARY

Adjustment devices in vehicles increasingly comprise auxiliary drives with which two vehicle parts which are can be adjusted relative to one another can be moved relative to one another without the vehicle passengers have to apply the torque necessary for this manually by themselves. An example for such auxiliary drives are electromechanical actuator arrangements which can be used, among other things, for actuating parking brakes of vehicles. Other auxiliary drives are used, for example, for longitudinal seat adjustments, rear gate adjustments, window raisers and roof closing adjustments.

Electromotors are used almost without exception as the drive source in auxiliary drives. The typically used electromotors frequently rotate at a comparatively high rotational speed so that high reductions of speed are necessary to be able to adjust the vehicle parts relative to each other with the desired, relatively slow movement. In addition, the torques made by the electromotor are frequently not sufficient to be able to move the vehicle parts so that reductions of speed are also necessary for this reason.

The available space in vehicles is designed to be small so that the transmissions used for the conversion of torque only have a small structural space. For this reason, planetary transmissions are frequently used in the drivetrain of the auxiliary drives which transmissions make possible ratios of large increases or reductions of speed in a small space. In many cases the auxiliary drives comprise a motor transmission arrangement in which the electromotor and the planetary transmission are combined in a structural unit.

The electromotors are supplied with a motor shaft projecting from the housing onto which a pinion, in the case of a planetary transmission the sun gear, is pressed on. For example, in EP 2 860 336 A2 or EP 2 860 338 A2 the sun gear is supported on the motor shaft in such a manner that it can axially move but is rotationally fixed.

In both cases, an additional working step is necessary in order to fasten the pinion on the motor shaft. Erroneous mountings can occur in this work step. In addition, the necessary number of pinions must be stored, as a result of which a corresponding storage is required. This complicates the mounting of the motor-transmission arrangement.

The present disclosure creates a motor-transmission arrangement which ameliorates the above-described situation. In particular, the mounting of the motor-transmission arrangement is simplified and the rejection rate is reduced.

An embodiment of the present disclosure relates to a motor-transmission arrangement, in particular for an adjustment device in vehicles for adjusting two vehicle parts which can be adjusted relative to one another, comprising a planetary transmission with at least one pinion cage, at least one planet wheel which is rotatably supported in the pinion cage and comprises a planet wheel cogging, and with at least one hollow gear with an inner cogging which engages with the planet wheel cogging. Furthermore, the motor transmission arrangement comprises an electromotor with a motor shaft which can rotate about a motor shaft axle and which motor shaft comprises a motor shaft cogging arranged directly on the motor shaft which cogging engages with the planet wheel cogging.

As a result of the fact that the motor shaft cogging is directly arranged on the motor shaft, the motor shaft itself forms the pinion or the sun gear without an additional structural part being necessary. Consequently, the mounting of the motor transmission part is simplified in such a manner that no pinion or sun gear must be stored and mounted. Interruption of the assembly due to lacking or defective sun gears or pinions can be avoided. In addition, defects produced during the fastening of the sun gear or of the pinion on the motor shaft are prevented.

According to another embodiment, the planetary transmission is constructed as a spiral gear planetary transmission, wherein the at least one planet wheel is supported in the pinion cage in such a manner that it can rotate about a planet wheel axle and the planet wheel axle runs in a warped manner to the motor shaft axle. In spiral gear planetary transmissions the sun gear cogging, in this case the motor shaft cogging, called a screw cogging, also frequently a spiral gear sun, and the hollow gear are constructed as an inner spiral gear. The planet wheel cogging is adapted to the spiral cogging of the spiral gear sun. The same applies to the inside cogging of the inside spiral gear. In this embodiment the planetary transmission is similar to so-called coaxial transmissions like those disclosed in WO 2015/036328 A1 and EP 2 166 252 A1.

An especially conspicuous feature of spiral gear planetary transmissions as well as of coaxial transmissions is the fact that the planet wheel axes do not run parallel to the axis of rotation of the worm but rather in a warped manner relative to it. In addition to the ratios of large increases or reductions of speed, spiral gear planetary transmissions make available a smooth running behavior with a low production of noise.

In a further-developed embodiment the planetary transmission and in particular the spiral gear planetary transmission are constructed in one stage. In comparison to multistage planetary transmissions, the complexity of the drive train is reduced, which simplifies the manufacture as well as the probability of failure and the required structural space are reduced. In particular, the structural space is small in the axial direction, which is an important feature in particular in the case of adjustments to the rear gate. The required conditions of increases or reductions of speed in particular in the case of rear gate adjustments can be made available especially well with spiral gear planetary transmissions.

In a further-developed embodiment the electromotor can comprise a housing and the motor shaft can be supported by a first support section and a second support section axially and radially in and/or on the housing. The support in the housing of the electromotor is a good possibility since no additional measures have to be made in the transmission in order to support the motor shaft. In particular, no preventive measures must be made for the arranging of a support in the pinion cage, which distinctly simplifies the mounting since, in contrast to WO 2015/036328 A1, the first support section and also the second support section are arranged outside of the pinion cage. For the case that the planetary transmission is designed as a spiral gear planetary transmission, relatively high axial forces are transmitted onto the motor shaft so that the supports customarily used in electromotors for the motor shaft are not sufficient to receive the axial forces acting on the motor shaft. The support of the motor shaft ensures, according to this embodiment, that the motor shaft is sufficiently supported in the axial direction.

In another embodiment the first support section and/or the second support section can each comprise a sliding bearing for radially supporting the motor shaft. Sliding bearings are distinguished by a simple construction which saves space, for example, compared to ball bearings and can be readily mounted. In addition, sliding bearings are distinguished by a relatively low weight. Given an appropriate selection of the sliding bearings, they can be operated maintenance-free. Sliding bearings are especially suitable on account of their place-saving construction and their low weight for using auxiliary drives in vehicles.

A further-developed embodiment is distinguished in that at least one support disk is connected to the motor shaft with which the motor shaft is axially supported in at least one of the support sections. The support disk can be pressed onto the motor shaft so that no further measures are necessary for the axial fastening of the support disk on the motor shaft. The use of a bearing disk represents a very simple manner for the axial support which furthermore saves space and weight.

According to another embodiment the at least one support disk rests on the sliding bearing. The sliding disk makes contact during the operation of the motor-transmission arrangement with an axially adjacent structural part which produces a wear position. Since sliding bearings are manufactured from materials which produce a low friction upon contact between two structural parts moving relative to one another, the wear is kept low without a lubrication be necessary. The use of the sliding bearing as an axial stop for the support disk utilizes the wear-reducing property of the sliding bearing not only as regards the motor shaft but also the support disk. The sliding bearing is supported in the housing of the electromotor housing. The support disk has a diameter greater than the outside diameter of the sliding bearing so that an axial securing of the motor shaft is created even if the sliding bearing should become loose or worn.

Another embodiment is distinguished in that the motor shaft cogging has an outside cogging diameter and that the motor shaft has a first motor shaft diameter in a first shaft section following the motor shaft cogging, wherein the cogging diameter is smaller than or equal to the first motor shaft diameter. This makes the mounting more flexible since the motor shaft cogging presents no hindrance during the mounting. In particular, the support disk can be pushed from both ends onto the motor shaft. The same also applies to the sliding bearing. In addition, the ratios of large increases or reductions of speed of the planetary transmission increase with decreasing cogging diameter of the outer motor shaft cogging. The elevation of the increase ratio can be converted, for example, by a reduction of the tooth number of the motor shaft cogging. The motor shaft diameter is linked via a steady module to the tooth number and consequently decreases as a result of a reduction of the tooth number. In order to raise the increase ratio, the tooth number of the inside cogging of the hollow gear can be raised.

According to another embodiment the first support section or the second support section supports a roller bearing for the radial and axial supporting of the motor shaft. To this end, for example, ball bearings can be used which are economically available and make available an axial and also a radial support. The use of support disks like those required in sliding bearings can be dispensed with so that the number of structural parts can be reduced.

According to another embodiment the roller bearing is arranged in the first shaft section and the motor shaft comprises a second shaft section with a second shaft diameter which is smaller than the first shaft diameter. There is the possibility here of arranging the motor shaft cogging on the first shaft section and the second shaft section in such a manner that the second shaft section is located at least for the most part inside the electromotor. In particular, the volume required for the coils of the electromotor greatly increases with the shaft diameter in the electromotor. The smaller the shaft diameter of the motor shaft in the electromotor is, the smaller the diameter or the radial extension of the electromotor can also be selected to be so that the motor-transmission arrangement can be compactly designed. The arrangement of the roller bearing in the first shaft section, which has the greater first shaft diameter, makes it possible to sufficiently dimension the roller bearing so that the probability of failure during the operation of the motor-transmission arrangement is very low.

Another embodiment is characterized in that the hollow gear is connected in a non-rotating manner to the electromotor. In general, it is simpler to fasten the hollow gear or the inside spiral gear in a non-rotating manner on the electromotor than to connect the hollow gear or the inside spiral gear axially fixed but rotationally to the electromotor. In addition, the motor-transmission arrangement has no rotatable parts on the outside since the inside spiral gear surrounds the rotating pinion cage, as a result of which the safety during the operation of the motor-transmission arrangement can be increased.

In another embodiment an adapter can be arranged between the hollow gear and the electromotor which adapter is connected in a non-rotating manner to the electromotor and the hollow gear. The use of an adapter makes it possible to connect a given planetary transmission to different electromotors without very great constructive changes being necessary. In many instances it is sufficient to appropriately adapt the adapter. For the case that the planetary transmission and in particular the hollow gear are manufactured from plastic and are injection-molded, it can be that in order to avoid undercuts the hollow gear has only a small connection surface with which the hollow gear can be fastened on the housing of the electromotor. The small connection surface can be too small, for example, when the hollow gear is adhered on the housing of the electromotor in order to securely receive the occurring torques. The adapter can be designed in such a manner that the connection surfaces are enlarged without the housing of the electromotor having to be changed. Consequently, the transmittable torques can be readily enlarged. Furthermore, the transmission play can be relatively simply changed with an appropriate adaptation of the adapter if this should be necessary.

An embodiment of the disclosure relates to the using of a motor-transmission arrangement according to one of the previously described embodiments for an adjustment device in vehicles for adjusting two vehicle parts which can be adjusted relative to one another. In addition, an embodiment of the disclosure relates to an adjustment device in vehicles for adjusting two vehicle parts which can be adjusted relative to one another with a transmission arrangement according to one of the previously described embodiments. The technical effects and advantages which can be achieved by the suggested use and the suggested adjustment device correspond to those which were discussed for the present motor-transmission arrangement. In particular, the mounting can be simplified and downtimes due to lacking or defective pinions or sun gears can be avoided. In addition, errors during the fastening of the pinion or sun gears on the motor shaft can be eliminated as mounting errors.

In another embodiment of the use the adjustment device can be designed as a rear gate adjustment. The simplified and error-reduced mounting of the motor-transmission arrangement becomes especially important in rear gate adjustments, also designated as rear gate drives.

According to a further-developed embodiment of the usage, the planetary transmission is designed as a spiral gear planetary transmission. As mentioned, ratios of large increases or reductions of speed can be realized with spiral gear planetary transmissions with a small structural space. It is especially possible here to design the spiral gear planetary transmission in one stage. In addition, spiral gear planetary transmissions make available a quiet running behaviour with a low development of noise. These qualities play an especially large part in rear gate adjustments.

Another implementation of the present disclosure relates to an electromotor, in particular for being used in a motor-transmission arrangement according to one of the previously described embodiments, wherein the electromotor comprises a motor shaft which can rotate about a motor shaft axle and which comprises a motor shaft cogging arranged directly on the motor shaft. The technical effects and advantages which can be achieved with the electromotor correspond to those mentioned for the motor-transmission arrangement.

In a further-developed implementation the electromotor comprises a housing, wherein the motor shaft is axially and radially supported in the housing by a first support section and a second support section. The support in the housing of the electromotor is a possibility since no additional measures have to be made in the transmission to support the motor shaft. In particular, the first and the second support section of the motor shaft are not located in the pinion cage, in comparison to the support arrangement shown, for example, in WO 2015/036328 A1, but rather outside of the pinion cage. For the case that the planetary transmission is designed as a spiral gear planetary transmission, comparatively high axial forces are transferred onto the motor shaft so that the supports customarily used for electromotors are not sufficient for the motor shaft for receiving the axial forces acting on the motor shaft. The support of the motor shaft according to this embodiment ensures that the motor shaft is sufficiently supported in particular in the axial direction.

In addition, an implementation of the present disclosure relates to an adjustment device in vehicles for adjusting two vehicle parts which can be adjusted relative to one another, comprising at least one motor-transmission arrangement according to one of the previously discussed embodiments. The technical effects and advantages which can be achieved with the adjustment device correspond to those mentioned for the motor-transmission arrangement.

### BRIEF DESCRIPTION OF DRAWINGS

Exemplary embodiments of the present application are explained in detail in the following with reference made to the attached drawings. In the drawings:

FIG. 1a shows a first embodiment of a motor-transmission arrangement according to the present application using a sectional view in a state which is not completely mounted,

FIG. 1b shows the motor-transmission arrangement shown in FIG. 1a using a perspective view in a state which is not completely mounted,

FIG. 1c shows the motor-transmission arrangement shown in FIG. 1a using a sectional view in a state which is completely mounted,

FIG. 2 shows a second embodiment of the motor-transmission arrangement,

FIG. 3 shows a third embodiment of the motor-transmission arrangement,

FIG. 4 shows a fourth embodiment of the motor-transmission arrangement, using a sectional view in the finished, mounted state,

FIG. 5 shows a fifth embodiment of the motor-transmission arrangement, wherein the transmission is omitted,

FIG. 6 shows a sixth embodiment of the motor-transmission arrangement, wherein the transmission is omitted, and

FIG. 7 shows a basic view of an adjustment device in a vehicle.

### DETAILED DESCRIPTION

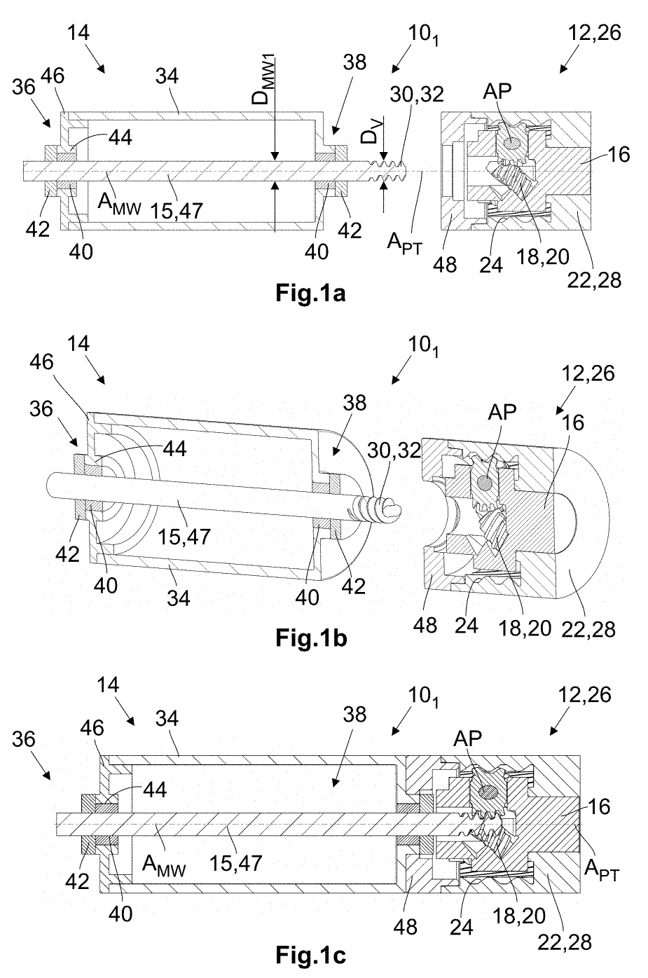

FIGS. 1a to 1c show a first embodiment of a motor-transmission arrangement 10₁ according to the present disclosure using different views in different mounting states. The motor-transmission arrangement 10₁ comprises a planetary transmission 12 and an electromotor 14. The electromotor 14 is provided with a motor shaft 15 which can rotate about a motor shaft axle A_{MW}.

The planetary transmission 12 comprises a pinion cage 16 which defines a pinion cage axle A_{PT} and on which a total of three planet wheels 18 are supported in a rotatable manner about a planet wheel axis A_{P}. The planet wheels 18 comprise a planet wheel cogging 20. Furthermore, the planetary transmission 12 comprises a hollow gear 22 with an inside cogging 24 which engages with the planet wheel cogging 20.

In the embodiment shown, the planetary transmission 12 is designed as a spiral gear planetary transmission 26. In this embodiment the planet wheel axes A_{P} run in a warped manner to the pinion cage axle A_{PT}. Moreover, the hollow gear 22 is designed here as an inside spiral gear 28. The motor shaft 15 comprises a motor shaft cogging 30 arranged directly on the motor shaft 15 which cogging is designed as a spiral cogging of a spiral gear sun 32. The motor shaft cogging 30 forms an end of the motor shaft 15. The planet wheel cogging 20 and the inside cogging 24 of the inside spiral gear 28 are adapted to the spiral cogging of the spiral gear sun 32 in order to make available the most optimal engagement possible inside the spiral gear planetary transmission 26.

The electromotor 14 comprises a housing 34 and a first support section 36 and a second support section 38 for the axial and radial supporting of the motor shaft 15 in the electromotor 14. In the first embodiment of the motor-transmission arrangement 10₁ the first support section 36 as well as the second support section 38 each comprise a sliding bearing 40 and the support disk 42 pressed onto the motor shaft 15. The two sliding bearings 40 for the are each fastened in a cylindrical receptacle 44 of the housing 34 of the electromotor 14. The two support disks 42 on arranged outside of the housing 34 and lie axially on one of the sliding bearings 40, wherein a certain axial play is provided in order to avoid a static coincidence. The housing 34 of the electromotor 14 comprises a cover 46 which forms the cylindrical receptacle 44 for the sliding bearing 40.

The motor shaft 15 comprises a first shaft section 47 in which the motor shaft 15 comprises a first motor shaft diameter D_{MW1}. The motor shaft cogging 30 comprises an outer cogging diameter D_{V}. Depending on the cogging selected, the outer cogging diameter D_{V} can be the crown line diameter. In the first embodiment shown, the outer cogging diameter D_{V} is equal to the first motor shaft diameter D_{MW1}, wherein the outer cogging diameter D_{V} can also be selected to be smaller than the first motor shaft diameter D_{MW1}. Consequently, the sliding bearings 40 and the support disks 42 can be pushed over the motor shaft cogging 30 or the motor shaft cogging 30 can be run through the sliding bearing 40. Depending on the requirement, the cogging diameter D_{V} can also be selected to be greater than the motor shaft diameter D_{MW1}. In particular, the variation of the cogging diameter D_{V} is a possibility for the adaptation of the translation ratios.

Furthermore, the motor-transmission arrangement 10₁ comprises an adapter 48 which is fastened in the mounting state shown in FIGS. 1a and 1b on the inner spiral gear 28, for example, by calking, adhering or welding. The adapter 48 can be adapted to the various geometric properties of the housing 34 of the electromotor 14 so that the planetary transmission 12 can be connected unchanged or nearly unchanged to different electromotors to a motor-transmission arrangement 10₁.

In order to connect the planetary transmission to the electromotor 14, they are aligned in such a manner relative to one another that the motor shaft axle A_{MW} and the pinion cage axle A_{PT} are in alignment with one another. The motor shaft 15 is subsequently brought with the motor shaft cogging 30 into the planetary transmission 12 so that the motor shaft cogging 30 engages with the planet wheel cogging 20. The adapter 48 is dimensioned in such a manner that when the motor shaft cogging 30 is engaged with the planet wheel cogging 20, the adapter 48 rests on the housing 34 of the electromotor 14. The adapter 48 is now connected to the housing 34, for example, by adhering, screwing or welding. The motor-transmission arrangement 10₁ is now in the finished, mounted state shown in FIG. 1c.

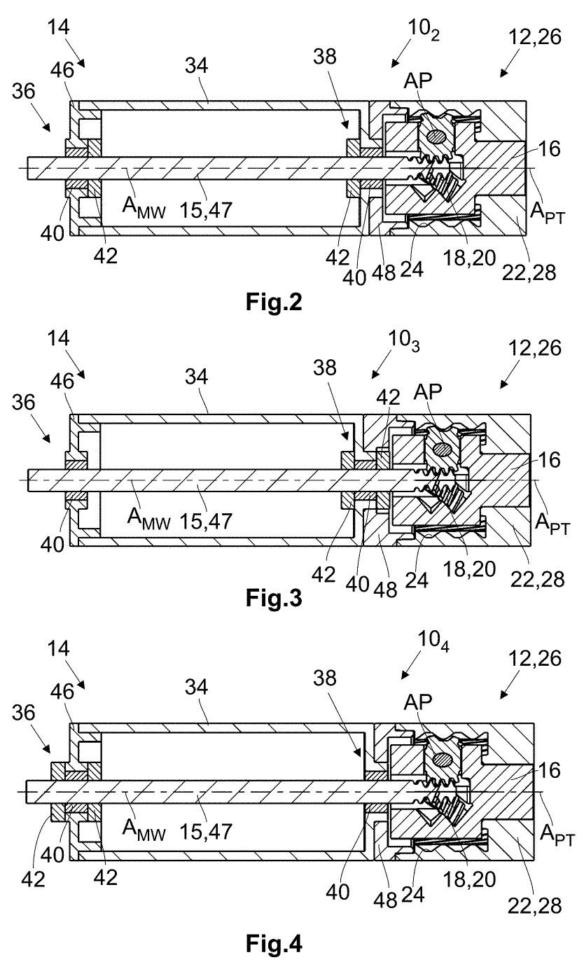

FIGS. 2 to 4 show a second, third and fourth embodiment of the motor-transmission arrangement 10₂ to 10₄ using a sectional view in the finished, mounted state. The embodiments shown there differ substantially in the formation of the first support section 36 and of the second support section 38.

In the second embodiment of the motor-transmission arrangement 10₂ the support disk 42 are arranged inside the housing 34 of the electromotor 14. As a result thereof, the planetary transmission 12 can be arranged closer to the electromotor 14 by the width of the support disk 42 so that the axial construction space of the motor-transmission arrangement 10₁ can be reduced in a corresponding manner. The adapter 48 is axially designed to be correspondingly shorter.

In the third embodiment of the motor-transmission arrangement 103 both support disks 42 are arranged in the second support section 38, wherein one of the support disks 42 is arranged inside and the other one of the support disks 42 is arranged outside of the housing 34.

In the fourth embodiment of the motor-transmission arrangement 10₄ both support disks 42 are arranged in the first support section 36, wherein one of the support disks 42 is arranged inside and the other one of the support disks 42 is arranged outside of the housing 34. As in the second embodiment, the planetary transmission 12 can be arranged closer to the electromotor 14 by the width of the support disk 42.

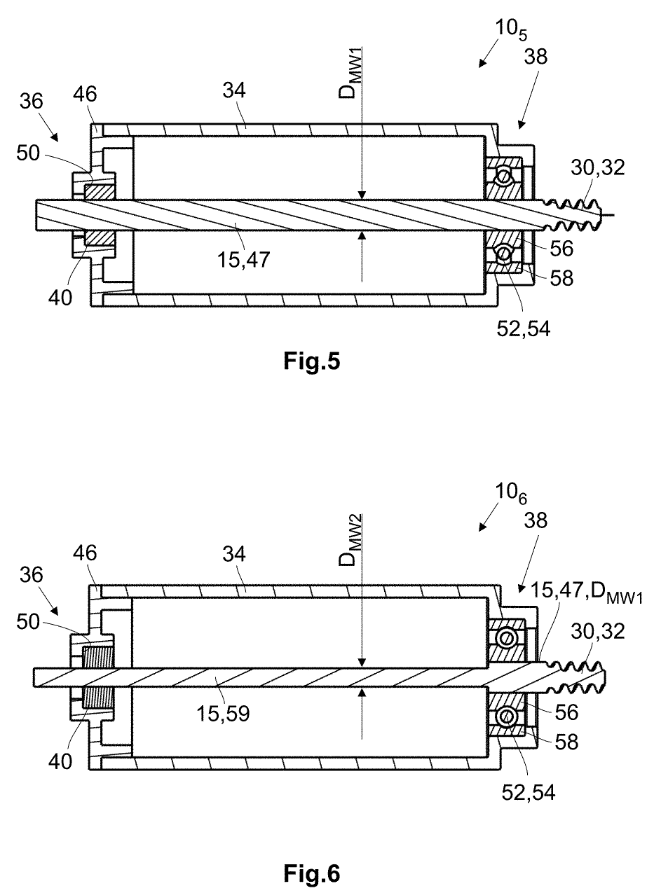

FIG. 5 shows a fifth exemplary embodiment of the motor-transmission arrangement 10₅, wherein, however, the planetary transmission 12 is not shown. The planetary transmission 12 can be constructed and connected to the housing 34 of the electromotor 14 as in the previously described exemplary embodiments. In this exemplary embodiment a sliding bearing 40 is also arranged in the first support section 36, as in the previously described exemplary embodiment, which bearing rests on a shoulder 50 of the housing 34 and is axially secured. A roller bearing 52, in the example shown a ball bearing 54, is arranged in the second support section 38 with which bearing the motor shaft 15 is supported not only radially but also axially. An inner ring 56 of the ball bearing 54 is pressed onto the motor shaft 15 and an outer ring 58 is fixed in the housing 34 of the electromotor 14. The arrangement of the sliding bearing 40 and of the roller bearing 52 can also be inverted so that the roller bearing 52 is arranged in the first support section 36 and the sliding bearing 40 is arranged in the second support section 38.

FIG. 6 shows a sixth exemplary embodiment of the motor-transmission arrangement 10₆ in which the planetary transmission 12 is also not shown. The motor-transmission arrangement 10₆ is designed to be largely identical to the motor-transmission arrangement 10₅ according to the fifth exemplary embodiment. However, the first shaft section 47 in which the motor shaft 15 has the motor shaft diameter D_{MW1} does not extend over the entire motor shaft 15 but closes approximately flush with the end of the ball bearing 54 facing the interior of the electromotor 14. The first shaft section 47 directly follows the motor shaft cogging 30 and has the first motor shaft diameter D_{MW1} which is equal to the cogging diameter D_{V}, as is also shown in FIG. 1a. Behind the first wave section 47, viewed from the motor shaft cogging 30, the motor shaft 15 comprises a second shaft section 59 with a second motor shaft diameter D_{MW2} which is smaller than the first motor shaft diameter D_{MW1}. The second shaft section 59 with the second motor shaft diameter D_{MW2} extends up to the end of the motor shaft 15, which end is opposite the motor shaft cogging 30, so that the sliding bearing 40 makes contact in the second wave section 59 in contrast to the fifth exemplary embodiment of the motor-transmission arrangement 10₅, that is, where the motor shaft 15 has the second motor shaft diameter D_{MW2}. Just as in the fifth exemplary embodiment of the motor-transmission arrangement 10₅, the ball bearing 54 is arranged in the first shaft section 47 in which the motor shaft 15 has the first motor shaft diameter D_{MW1}.

In all embodiments of the motor-transmission arrangement 10 the two support sections 36, 38 are arranged in the housing 34 of the electromotor so that no support has to be arranged in the pinion cage 16, which simplifies the mounting.

For reasons of presentation, the cogging diameter DV is shown only in FIG. 1a. However, the explanations about the cogging diameter D_{V} also apply to the second to the sixth exemplary embodiments of the motor-transmission arrangement 10₂-10₅.

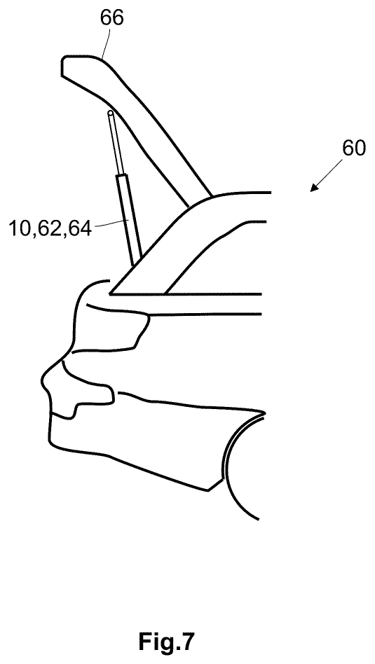

FIG. 7 partially shows a vehicle 60 using a basic side view, which comprises an adjustment device 62 for adjusting two vehicle parts that can be adjusted relative to one another. In this case the adjustment device 62 is constructed as a rear gate adjustment 64 with which a rear gate 66 of the vehicle 60 can be adjusted relative to the rest of the vehicle 60 and can therefore be opened and closed. The rear gate adjustment 64 comprises a motor-transmission arrangement 10 according to one of the previously described embodiments which is not explicitly shown in FIG. 5.

### LIST OF REFERENCE NUMERALS

10, 10₁ to 10₆ motor-transmission arrangement
12 planetary transmission
14 electromotor
15 motor shaft
16 pinion cage
18 planet wheel
20 planet wheel cogging
22 hollow gear
24 inside wheel cogging
26 spiral gear planetary transmission
28 inside spiral gear 28
30 motor shaft cogging
32 spiral gear sun
34 housing
36 first support section
38 second support section
40 sliding bearing
42 support disk
44 cylindrical receptacle
46 cover
47 first shaft section
48 adapter
50 shoulder
52 roller bearing
54 ball bearing
56 inner ring
58 outer ring
60 vehicle
62 adjustment device
64 rear gate adjustment
66 rear gate
A_{MW} motor shaft axle
A_{P} planet wheel axle
A_{PT} pinion cage axle
D_{MW1} first motor shaft diameter
D_{MW2} second motor shaft diameter
D_{V} cogging diameter

What is claimed:

1. A motor-transmission arrangement comprising:
a planetary transmission comprising:
a pinion cage;
a planet wheel that is rotatably supported in the pinion cage and that has a planet wheel cogging;
a hollow gear having an inside cogging which engages with the planet wheel cogging; and
an electromotor with a motor shaft having a motor shaft axle, wherein the motor shaft rotates about the motor shaft axle and which comprises a motor shaft cogging arranged directly on the motor shaft, and wherein the motor shaft cogging engages with the planet wheel cogging.

2. The motor-transmission arrangement according to claim 1, wherein the planetary transmission comprises as a spiral gear planetary transmission, wherein the planet wheel is supported in the pinion cage in such a manner that the planet wheel rotates about a planet wheel axle and the planet wheel axle runs in a warped manner to a pinion cage axle.

3. The motor-transmission arrangement according to claim 2, wherein the planetary transmission and the spiral gear planetary transmission are constructed in one stage.

4. The motor-transmission arrangement according to claim 1, wherein the electromotor comprises a housing and the motor shaft is supported by a first housing support section and a second housing support section axially and radially in the housing.

5. The motor-transmission arrangement according to claim 4, wherein the first housing support section, the second housing support section, or both the first housing support section and the second housing support section, comprise a sliding bearing for radially supporting the motor shaft.

6. The motor-transmission arrangement according claim 5, further comprising a support disk is connected to the motor shaft and the motor shaft is axially supported in the first housing support section, the second housing support section, or both the first housing support section and the second housing support section.

7. The motor-transmission arrangement according to claim 6, wherein the support disk rests on the sliding bearing.

8. The motor-transmission arrangement according to claim 4, wherein the first housing support section, the second housing support section, or both the first housing support section and the second housing support section, support a roller bearing for the radial and axial supporting of the motor shaft.

9. The motor-transmission arrangement according to claim 8, wherein the motor shaft comprises a first motor shaft section with a first motor shaft diameter and second motor shaft section with a second motor shaft diameter, wherein the second motor shaft diameter is less than the first motor shaft diameter, and the roller bearing is arranged in the first motor shaft section.

10. The motor-transmission arrangement according to claim 1, wherein, that the hollow gear is connected in a non-rotating manner to the electromotor.

11. The motor-transmission arrangement according to claim 10, wherein an adapter is arranged between the hollow gear and the electromotor, wherein the adapter is connected in a non-rotating manner to the electromotor and the hollow gear.

12. The motor-transmission arrangement according to claim 1, wherein the motor operates a vehicle adjustment device for adjusting two vehicle parts which can be adjusted relative to one another.

13. The motor-transmission arrangement according to claim 12, wherein the adjustment device is a rear gate adjustment.

14. The motor-transmission arrangement according to claim 13, wherein the planetary transmission is designed as a spiral gear planetary transmission.

15. An electromotor, comprising:
a motor shaft having a motor shaft axle and which comprises a motor shaft cogging arranged directly on the motor shaft, wherein the motor shaft is configured to engage with a planetary transmission, wherein the planetary transmission comprises:
a pinion cage;
a planet wheel that is rotatably supported in the pinion cage and that has a planet wheel cogging;
a hollow gear having an inside cogging which engages with the planet wheel cogging; and
wherein the motor shaft cogging is configured to engage with the planet wheel cogging.

16. The electromotor according to claim 15, wherein the electromotor comprises a housing and that the motor shaft is axially and radially supported in the housing by a first housing support section and a second housing support section.
